(19) United States
(12) Patent Application Publication
(10) Pub. No.: US 2013/0202433 A1
(43) Pub. Date: Aug. 8, 2013

(54) SEAL ASSEMBLY FOR TURBINE COOLANT PASSAGEWAYS

(71) Applicant: Matthew Troy Hafner, Honea Path, SC (US)

(72) Inventor: Matthew Troy Hafner, Honea Path, SC (US)

(73) Assignee: GENERAL ELECTRIC COMPANY, Schenectady, NY (US)

(21) Appl. No.: 13/367,486

(22) Filed: Feb. 7, 2012

(51) Int. Cl. F02C 7/28; B23P 11/00; F16J 15/02

(52) U.S. Cl. 415/230; 277/630; 29/888.3

(57) ABSTRACT

A seal assembly for use with a turbine having a rotor and at least one turbine blade facilitates the use of a wire seal with seal plate segments. The seal assembly includes a plurality of seal plate segments and a plurality of retainers disposed on a rotor flange on the rotor. A seal member is disposed between the retainers and the seal plate segments. The seal assembly includes at least one attachment member disposed through the rotor flange that limits radial displacement of the seal plate segments.

### TECHNICAL FIELD

The subject matter disclosed herein relates to gas turbine rotors and, more particularly, is concerned with a seal assembly for sealing coolant passageways in turbine rotor blades disposed in the periphery of a turbine rotor disc.

### BACKGROUND

A typical gas turbine has a rotor (wheel) with a number of blades (buckets) distributed around the circumference of the rotor. The blades may be secured to the rotor using a conventional dovetail configuration. The blades are driven by hot gas from the combustion chamber and are cooled using a coolant that flows through passages in the blades. It is important to avoid the hot gases from coming into contact with the rotor.

A variety of seal configurations have been developed to prevent the hot gases from coming into contact with the rotor. In some cases a seal assembly may be positioned about the rim of rotor to seal off the hot gases. In some applications a wire seal may be disposed in a groove in the rotor to provide a more effective seal. Another approach is to provide a seal plate comprising of a number of seal plate segments each having seal wings that isolate the rim cavity from the hot gas path. The seal plate segments may be connected to the rotor using hooks and locking pins that capture the seal plates and prevent them from slipping out of the bladed rotor assembly when the turbine is not spinning, respectively. Wire seals can be used around the seal plates. The segmented seal plates usually rely on tight tolerances to control leakage area.

These devices have the disadvantage that, during installation, it is difficult to maintain the correct position of a wire seal while installing segmented seal plates onto the rotor.

### BRIEF DESCRIPTION OF THE INVENTION

In accordance with one exemplary non-limiting embodiment, the invention relates to a seal assembly for use with a turbine having a rotor and at least one turbine blade. The seal assembly includes a plurality of seal plate segments; a plurality of retainers disposed on a rotor flange on the rotor and or buckets; a seal member disposed between the retainers and the plurality of seal plate segments; and at least one attachment member disposed through the rotor flange that limits radial displacement of the seal plate segments.

In another embodiment, a method for providing a seal for a turbine having a rotor and at least one turbine blade is provided. The method includes positioning an inner diameter subassembly in a chamber formed by a rotor flange and a blade flange. The method further includes displacing the inner diameter subassembly in a radial direction within the chamber; and securing the inner diameter subassembly within the chamber.

In another embodiment, a turbine having a rotor with a rotor flange and a plurality of turbine blades each having a blade flange is provided. The rotor flange and the blade flange define a chamber. The turbine includes a plurality of seal plate segments disposed in the chamber and a plurality of retainers disposed on the rotor flange. A seal member that is disposed between the first plurality of retainers and the plurality of seal plate segments is provided. At least one attachment member that is disposed through the rotor flange to limit radial displacement of the seal plate segments is also provided.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cross section diagram of an illustrative embodiment of a seal assembly.

FIG. 2 is an alternate embodiment of an outer diameter retainer.

FIG. 3 is an alternate embodiment of an inner diameter retainer.

FIGS. 4-8 is an illustrative embodiment of a sequence for installing the seal assembly.

### DETAILED DESCRIPTION OF THE INVENTION

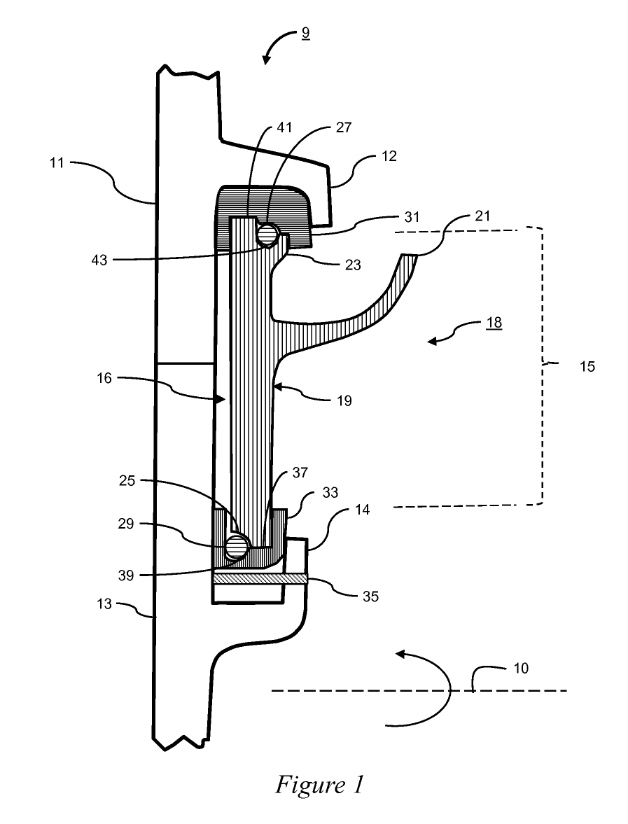

Illustrated in FIG. 1 is a rotor assembly 9 that may be used in a turbine system. The rotor assembly 9 rotates about an axis 10, and may include at least one turbine blade 11 having a blade flange 12. The blade flange 12 protrudes from the turbine blade 11 and angles towards the axis of rotation of the rotor assembly 9. The turbine blade 11 is secured to a rotor 13 by conventional means, such as for example a dovetail structure. The rotor 13 may be provided with a rotor flange 14 that protrudes from the rotor 13 and angles away from the axis of rotation of the rotor assembly 9. The blade flange 12 and the rotor flange 14 define an opening 15 and a chamber 16.

Disposed in the chamber 16 is a seal assembly 18 that may include a seal plate segment 19. The seal plate segment 19 may include an upper seal arm 21 and a plate segment flange 23. The seal plate segment 19 may also be provided with a beveled end 25. The seal assembly 18 has a radial dimension that is greater than the radial dimension of the opening 15 and smaller than the radial dimension of the chamber 16.

The seal assembly 18 may also include an outer diameter wire seal 27, and an inner diameter wire seal 29. The outer diameter wire seal 27 and the inner diameter wire seal 29 may be of any of a variety of cross-section such as for example circular, hexagonal, octagonal, and the like. Additionally, the outer diameter wire seal 27 and the inner diameter wire seal 29 may be a single filament or multiple filaments braided into a rope. The outer diameter wire seal 27 and the inner diameter wire seal 29 may be made of any of a number of known materials as necessary to survive in this operating environment such as high temperature steels, nickel alloys, ceramic, or a combination of any of the materials.

The seal assembly 18 may also include an outer diameter retainer 31 and inner diameter retainer 33 disposed at the ends of the seal plate segment 19. The seal assembly 18 may be disposed within the chamber 16 and an attachment member such as a pin 35 may be provided to limit the radial displacement of the seal assembly 18 within the chamber 16. The inner diameter retainer 33 may have a C-shaped cross-section and may include a seat portion 37 adapted to receive one of the ends of the seal plate segment 19. One or more inner diameter retainers 33 provide a carrier ring that facilitates the use of the inner diameter wire seal 29 with a plurality of seal plate segments 19. The inner diameter retainer 33 could be a ring, split in one location to allow it to be expanded over the rotor flange and compressed inside the rotor flange. Optionally, the inner diameter retainer 33 may be provided with a recess 39 to accommodate the inner diameter wire seal 29. Similarly, the outer diameter retainer 31 may include a seat portion 41 adapted to receive and end of the seal plate segment 19 and may be provided with a recess 43 to accommodate the outer diameter wire seal 27. The inner diameter retainer 33 in the outer diameter retainer 31 may be made of materials suitable for use in a turbine environment. The materials may include various alloys of steel, nickel, and coatings to protect the components.

As illustrated in FIG. 1 the chamber 16 has a radial dimension that is larger than the radial dimension of the seal assembly 18. The increased dimension provides some play (loose fit) with regard to the location of the seal assembly 18 within the chamber 16 before the pin 35 is inserted. The ability to move the seal assembly 18 within the chamber 16 enables easy installation of the seal assembly 18. After installation the radial movement of the seal assembly 18 is restricted by pin 35. This embodiment facilitates the installation of a seal assembly having a wire seal (such as for example inner diameter wire seal 29) and seal plate segments (such as for example seal plate segment 19) onto a turbine rotor. Additionally, this embodiment may be used to combine a sealing system with the blade (bucket) retention system.

Illustrated in FIG. 2 is an alternate embodiment of a retainer 45. In this embodiment, the retainer 45 may be provided with a C shaped cross-section having a seat portion 47 adapted to engage with a portion of an end of seal plate segment 19. A wire seal 49 may be disposed between the retainer 45 and the seal plate segment 19. The seal plate segment 19 may be provided with a J-shaped cross-section (groove) at the end to provide a recess 51 for the wire seal 49.

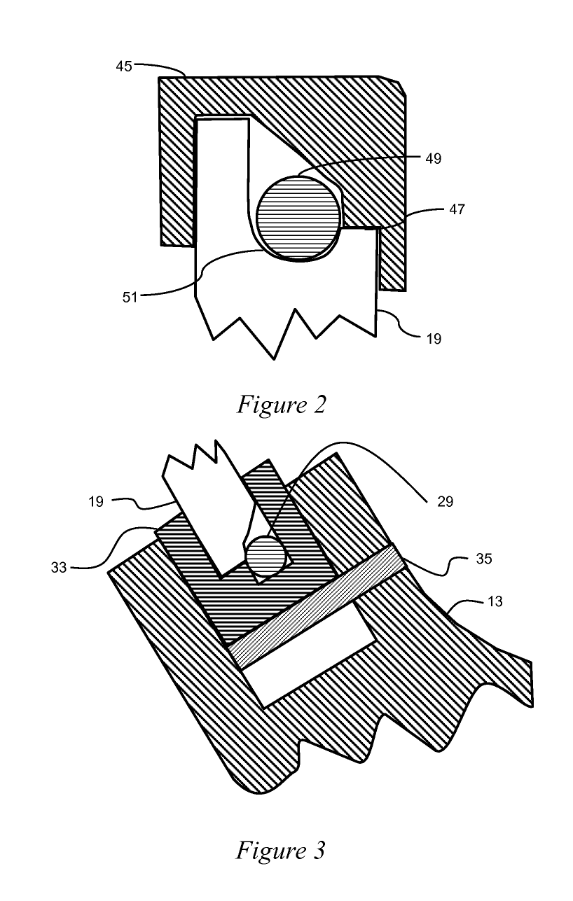

As may be seen from FIG. 3, the location of the inner diameter wire seal 29 with respect to the seal plate segments 19 and the retainer 33 may be varied. Consequently, the various embodiments of the shape and location of the inner diameter retainer 33, the inner diameter wire seal 29, the outer diameter retainer 31 and the outer diameter wire seal 27 are not intended in any way to be limiting.

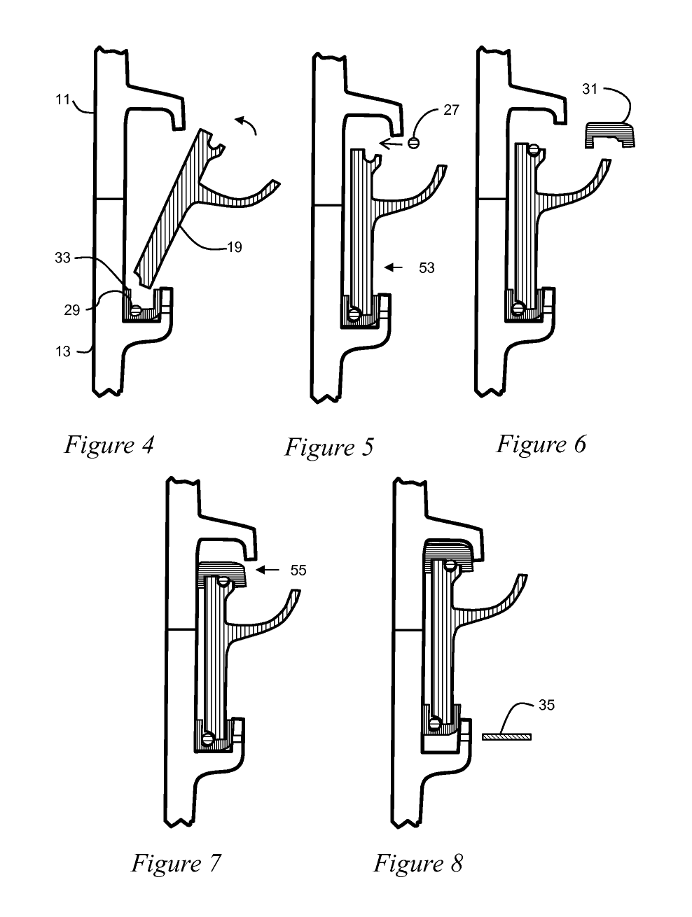

Illustrated in FIGS. 4 through 8 is an exemplary embodiment of a method of installation of the seal assembly 18 to provide a seal for a rotor assembly 9. In FIG. 4 the inner diameter wire seal 29 and the inner diameter retainer 33 are shown disposed in the rotor flange 14. At least one function of the inner diameter retainer 33 (internal diameter split ring) is to correctly position and hold the inner diameter wire seal 29 during assembly. The seal plate segment 19 is then positioned with one end engaging the inner diameter retainer 33. In FIG. 5 the inner diameter subassembly 53 comprising the inner diameter retainer 33, the seal plate segment 19, and the inner diameter wire seal 29 are shown in place and the outer diameter wire seal 27 may then be inserted. Finally, the outer diameter retainer 31 is inserted as in FIG. 6. The outer diameter retainer(s) 31 (outer diameter split ring) may also provide axial blade (bucket) retention. With the outer diameter subassembly 55 comprising the outer diameter retainer 31 and the outer diameter wire seal 27 in place the entire seal assembly 18 is displaced upwards and the pin 35 is inserted. With the pin 35 in place the seal assembly 18 is prevented from being displaced.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A seal assembly for use with a turbine having a rotor and at least one turbine blade, comprising
at least one seal plate segment;
at least one inner diameter retainer disposed on a rotor flange on the rotor;
a first seal member disposed between the inner diameter retainer and the seal plate segment; and
at least one attachment member disposed through the rotor flange that limits radial displacement of the seal plate segment.

2. The seal assembly of claim 1 further comprising at least one outer diameter retainer disposed adjacent to a blade flange on the turbine blade.

3. The seal assembly of claim 1 wherein the seal plate segment comprises a seal arm and a beveled end portion.

4. The seal assembly of claim 1 wherein the seal plate segment includes a recessed portion for supporting the first seal member.

5. The seal assembly of claim 2 wherein the rotor flange and the blade flange define an opening having a dimension that can accommodate the insertion of the seal plate segment.

6. The seal assembly of claim 2 wherein the rotor flange and blade flange define a retaining chamber having a dimension that provides sufficient play to accommodate the insertion of the outer diameter retainer.

7. The seal assembly of claim 1 wherein the seal member is a wire seal member.

8. The seal assembly of claim 7 wherein the inner diameter retainer includes a recessed portion to accommodate the wire seal member.

9. The seal assembly of claim 8 wherein the wire seal member comprises a wire seal rope.

10. A method for providing a seal for a turbine having a rotor with at least one rotor flange and at least one turbine blade with a blade flange, the method comprising:
positioning an inner diameter subassembly in a chamber formed by the rotor flange and the blade flange;
displacing the inner diameter subassembly in a radial direction within the chamber; and
securing the inner diameter subassembly within the chamber.

11. The method of claim 10 wherein the inner diameter subassembly comprises:
an inner diameter retainer;
a first seal member; and
a seal plate segment.

12. The method of claim 11 further comprising positioning an outer diameter subassembly on the seal plate segment.

13. The method of claim 12 wherein the method element of positioning the inner diameter subassembly and outer diameter subassembly comprises inserting the inner diameter subassembly and the outer diameter subassembly through an opening defined by the rotor flange and the blade flange.

14. The method of claim 10 wherein the method element of securing the inner diameter subassembly to the rotor comprises inserting a pin through the rotor flange and adjacent to the seal assembly.

15. A turbine comprising:
a rotor having at least one rotor flange;
at least one turbine blades having a blade flange;
a chamber defined by the blade flange and the rotor flange;
at least one seal plate segment disposed in the chamber;
at least one inner diameter retainer disposed in the chamber and proximate to the rotor flange;
a first seal member disposed between the inner diameter retainer and the seal plate segment; and
at least one attachment member disposed through the rotor flange that limits radial displacement of the seal plate segment.

16. The turbine of claim 15 further comprising at least one outer diameter retainer disposed on the seal plate segment.

17. The turbine of claim 15 wherein the rotor flange and the blade flange define an opening having a dimension that can accommodate the insertion of the seal plate segment.

18. The turbine of claim 15 wherein the first seal member is a wire rope seal.

19. The turbine of claim 15 wherein the attachment member is a pin.

20. The turbine of claim 15 further comprising a second seal member disposed between the outer diameter retainer and the seal plate segment.
